(19) United States
(12) Patent Application Publication
(10) Pub. No.: US 2007/0163331 A1
(43) Pub. Date: Jul. 19, 2007

(54) LINE LEAK DETECTOR

(75) Inventor: Ian F. Jarvie, Woodridge, IL (US)

Correspondence Address: WOOD, HERRON & EVANS, LLP, 2700 CAREW TOWER, 441 VINE STREET, CINCINNATI, OH, 45202, US

(73) Assignee: DELAWARE CAPITAL FORMATION, INC., Wilmington, DE (US)

(21) Appl. No.: 11/623,525

(22) Filed: Jan. 16, 2007

Related U.S. Application Data
(60) Provisional application No. 60/760,116, filed on Jan. 19, 2006.

(51) Int. Cl. G01M 3/04; G01F 17/00

(52) U.S. Cl. 73/49.2; 73/149

(57) ABSTRACT

A leak detector for detecting volumetric changes in a liquid volume includes a biased piston disposed in a housing and a liquid passage extending from the liquid volume to an expansible chamber defined by the housing and piston. The leak detector further includes a magnetostrictive sensor including a magnetostrictive waveguide, a magnet operably coupled to the piston and moveable therewith and pulsing and detection devices for detecting the position of the magnet along the magnetostrictive waveguide. A method of using the detector includes exposing the expansible chamber to liquid from the liquid volume and sensing the changes in the liquid volume magnetostrictively by causing relative movement between the waveguide and the magnet to obtain data representative of piston movement which is responsive to volumetric changes in the liquid volume.

### CROSS REFERENCE TO RELATED APPLICATIONS

This application claims priority to provisional patent application Ser. No. 60/760,116 filed on Jan. 19, 2006, the disclosure of which is expressly incorporated by reference herein in its entirety.

### FIELD OF THE INVENTION

This invention relates to leak detection and has particular application to the detection of leakage from pressurized fuel delivery lines in dispensing operations such as gas stations.

### BACKGROUND OF THE INVENTION

Leakage into the environment of petroleum products, including gasoline, is damaging to surrounding soils and water. Once a leak is detected, clean up or remediation is costly and time consuming.

In a dispensing operation such as a gas station, fuel is typically stored in underground storage tanks (“UST”) from where it is pumped through pipes to an above ground pump or dispensing unit for dispensing into vehicles. Leaks of fuel from the tank or from the interconnecting pipe lines to the dispensers can cause significant environmental damage. The United States Environmental Protection Agency has set certain standards for the detection and prevention of environmental leaks. It accordingly has been a goal of manufacturers of this equipment to detect leaks and to meet EPA standards in this regard.

For example, as this application is filed, the EPA requires detection methods sufficient to detect volumetric leak rates of 0.1 gallons per hour. In addition, the EPA requires a detection rate of no less than at least 95% accuracy with false leakage alarms no more than 5%.

A variety of devices operating on a variety of physical principles have been proposed to meet these standards and thereby warn of leaks and provide means for stopping the leaks as quickly as possible to reduce the impact on the surrounding environment. One such device and system is described in U.S. Pat. No. 5,091,716, which patent is expressly incorporated herein by reference as if fully expressly reproduced herein.

In that device, a detector is spliced into a fuel delivery line. The detector has a port allowing fuel in the fuel delivery line to engage a piston and displace it against the bias of a constant rate spring. In more particular detail, the patent discloses a line leak detector having a liquid reservoir which is adapted to be mechanically coupled to the liquid fuel line. The liquid reservoir is preferably in the form of a cylinder. A piston is also included in the liquid reservoir with the piston being moveable in response to the volume of liquid in the reservoir. A spring is also connected to the piston to provide a restoring force to movement of the piston. The piston includes a core mechanically coupled thereto for movement in response to the movement of the piston. A coil surrounds the core so that the core is moveable in the coil in response to the liquid in the reservoir. Movement of the core changes the electrical inductance of the coil. Accordingly, the exact position of the piston in the reservoir may be monitored by measuring the inductance changes in the coil. According to the patent, measurement of the coil inductance provides a highly accurate measurement of the volume of liquid in the reservoir so that an accurate measurement of a line leak may thereby be provided.

While such a device is accurate to a certain degree, certain features of the device limit the overall performance and the degree of accuracy which can be attained. For example, the device is spliced into a fuel line which is typically of a relatively larger cross-sectional flow area than the more restrictive cross-sectional flow area of the device. Since all the fuel must flow through the sensing device, the device thus constitutes a choke point in the fuel line, restricting the delivery of fuel through the line beyond the capacity of the larger line itself.

Moreover, it will be appreciated that the displacement sensing operation of the device works on the principle of electronic induction, i.e. a coil surrounding a movable core which changes the inductance of the coil as the core moves with the piston. Such devices are capable of measuring changes in the linear position of the core over certain ranges of movement, but the data provided is limited in that such devices can only register certain finite changes of position over the design stroke of the piston. These measurable changes are relatively large, as compared to the following description of the invention. As such, this known device has certain accuracy limitations in terms of the preciseness of its ability to detect minute positional changes in piston displacement smaller than the capacity of the inductive system to measure.

In addition, the collection of the limited data which is sensed in such devices requires certain minimum time periods. In other words, it takes a significant time period to collect sufficient data for analysis. The combination of a limited range of positional changes or data points with minimum times necessary for accumulation and data analysis restrict the sensitivity and timeliness of such prior devices, thus limiting the accuracy of the devices and their responsiveness in detecting leaks and providing leaking control. These limitations, together with others, result in a system which is better than having no detection, but which can still permit undetectable leakage or leakage over small periods of time which can accumulate to adversely impact the environment.

It is also recognized that even though current EPA standards are restrictive, small leaks which are undetectable under current EPA detection performance standards can accumulate over time to constitute massive long term environmental damage. Finally, it is recognized that the frequency of catastrophic leaks has increased recently, even with the leak detection systems which comply with current EPA standards.

Accordingly, it has been one objective of the invention to provide improved leak detection that exceeds current EPA standards.

A further objective of the invention has been to provide improved leak detection apparatus and methods capable of measuring smaller leaks over shorter time periods than heretofore known, while at the same time avoiding flow rate restrictions in fuel delivery lines.

### SUMMARY OF THE INVENTION

To these ends, the invention contemplates leak detection apparatus and methods wherein volumetric fuel changes are measured across a large range of multiple positional related data points not heretofore available in fuel detection, and over a shorter time than heretofore available. A biased piston moves in a bore ported to a fuel delivery line without restriction of the cross-sectional flow area of that line. The piston is connected to a magnet moving over a magnetostrictive waveguide and piston movement is detected by a pulsed magnetostrictive apparatus providing thousands of “positional measuring points” over the entire range of piston movement, such as, for example, 10,000 detectable position points along two inches of piston travel. Pulsed clock time along the magnetostrictive waveguide is preferably on the order of 64 MHz or greater, and with a counter running asynchronously to the waveguide, a combination of measurements of displacement are produced, providing a large number of data points in a small time period and a sensing result more accurate by orders of magnitude than the inductive device of U.S. Pat. No. 5,091,716.

In a preferred embodiment of the invention, at least 100 data points of piston movement can be quickly obtained to determine whether changes in fuel line volume indicate a leak or some other change not indicative of a leak.

Also, the invention in various embodiments contemplate use of a biasing member to bias the piston against the anticipated ranges of volumetric changes for the fuel volumes to be tested. For example, the biasing member may be configured as a constant or variable rate spring, a weight, an electromagnet, a permanent magnet, a regulated fluid supply, or a sealed gas pocket. This combination of elements may eliminate artifact sensed volumetric changes resulting from the progressive compression and expansion of air within the liquid volume sensed as well as provide other advantages.

Accordingly, the invention provides numerous and significant advantages over prior leak detection systems such as those of U.S. Pat. No. 5,091,716. More data points are gathered in significantly less time. Significantly smaller changes in volume are detected over significantly reduced time periods, thus minimizing absolute leak volumes. The impact of thermal variation caused changes is substantially reduced since thermal changes require time and the test window provided by the invention is significantly shorter than in prior systems, resulting in less artifact impact from thermal changes. Existence of air pockets in the fuel volume may be eliminated as a volume change factor resulting from use of a constant force or pressure biasing member. And significantly, fuel line flow rates are not adversely impacted upon installation of the invention since it is simply ported to the line and not inserted or spliced into the line as a choke point as was required in prior devices.

As a result of these and other features of the invention, a larger number of data points gathered over a shorter period of time, as compared to past systems, can be analyzed by appropriate algorithms (not part of this invention) to provide a more realtime indication of smaller leaks which can be acted on to prevent costly adverse environmental impact, and without restricting delivery system flow. EPA standards or minimums are exceeded on the favorable side and the leak detection capabilities of the invention provide enhanced integrity of fuel delivery systems.

While the invention finds primary application in petroleum product delivery and transport systems, these and other applications will be readily apparent to those of ordinary skill in the art from the following detailed description of preferred embodiments of the invention and from the drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a diagrammatic illustration of an exemplary fuel dispensing system;

FIG. 2 is a perspective disassembled view of an embodiment of a line leak detector in accordance with the invention;

FIG. 3A is a cross-sectional view of the line leak detector shown in FIG. 2 after assembly;

FIG. 3B is another cross-sectional view of the line leak detector shown in FIG. 2 after assembly;

FIG. 4 is a cross-sectional view of an alternate embodiment of the line leak detector in accordance with the invention;

FIG. 5 is a cross-sectional view of an alternate embodiment of the line leak detector in accordance with the invention;

FIG. 6 is a cross-sectional view of an alternate embodiment of the line leak detector in accordance with the invention;

FIG. 7 is a cross-sectional view of an alternate embodiment of the line leak detector in accordance with the invention;

FIG. 8 is a cross-sectional view of an alternate embodiment of the line leak detector in accordance with the invention; and

FIGS. 9A-9C are a flowchart illustration of an exemplary leak detection system using embodiments of the leak detector of the invention.

### DETAILED DESCRIPTION

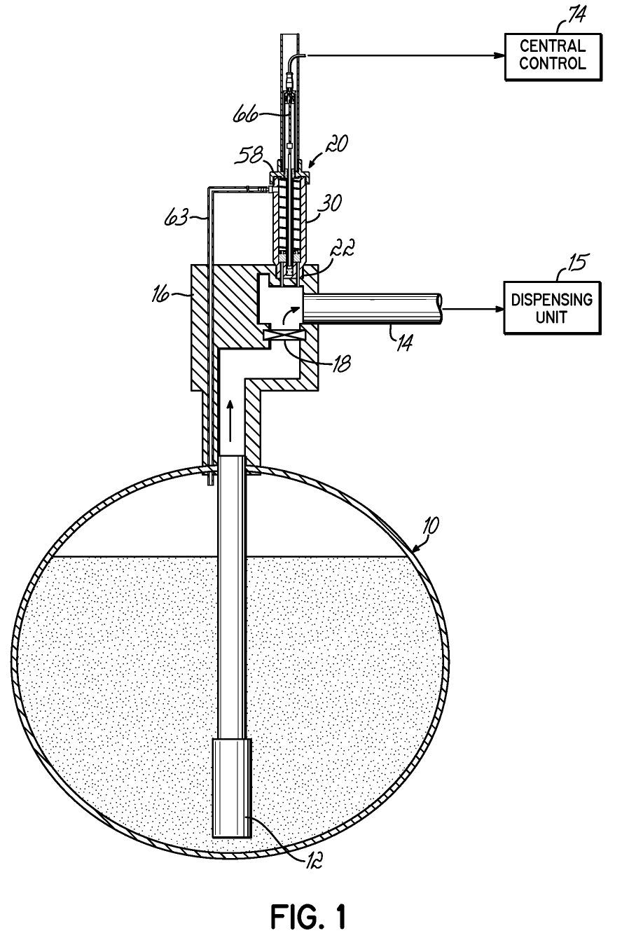

An exemplary fuel dispensing system of the invention is shown in FIG. 1 and generally includes an underground storage tank (“UST”) 10 for storing a fuel, a submersible pump 12 located in the tank 10, and a fluid conduit line 14 that transports the fuel under pressure to one or more dispensing units 15, shown schematically in FIG. 1. Typically, the fluid conduit line 14 is coupled to the submersible pump 12 via a pump manifold 16 that is typically located external to tank 10, such as in a covered manway. Pump manifold 16 includes a check valve 18 for preventing fuel from flowing back into tank 10. Because check valve 18 prevents any fuel from flowing back into tank 10, when the dispensing unit 15 is off, thus preventing fuel from flowing from conduit line 14, the fluid conduit line 14 defines a closed system containing an amount or volume of fuel that depends on several factors including length of conduit line 14, size of conduit line 14, and other factors. As mentioned above, to meet EPA regulations, the integrity of the fluid conduit line 14 must be regularly tested and the amount of any fuel leakage therefrom monitored.

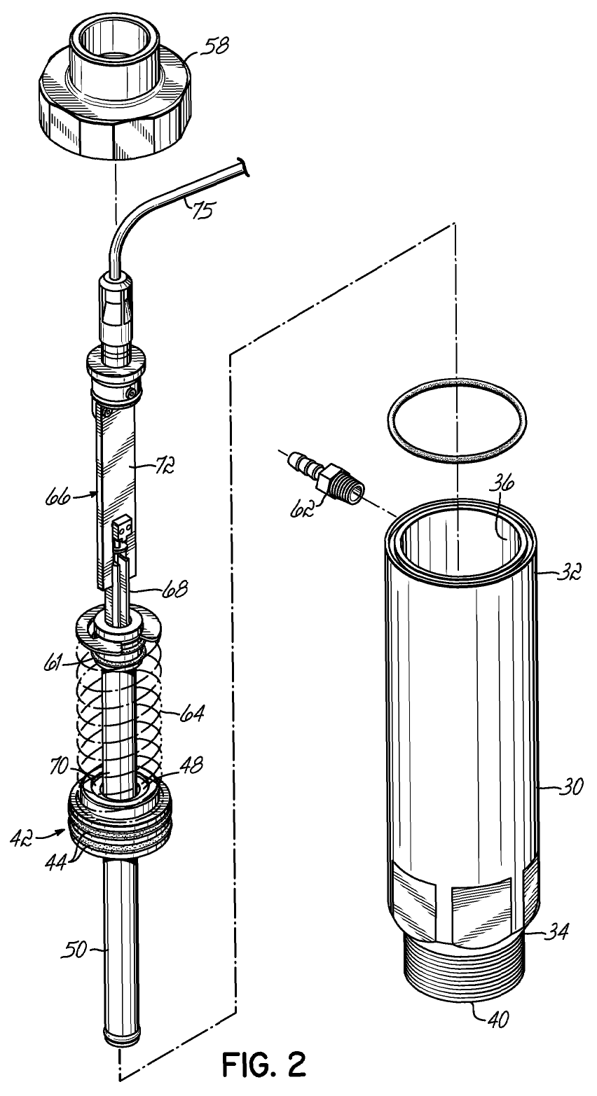

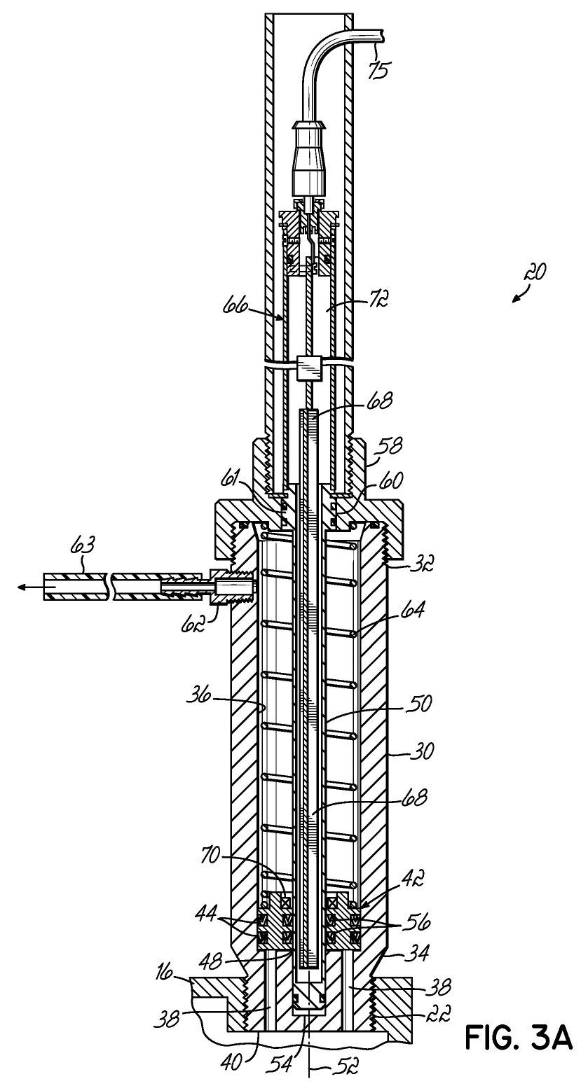

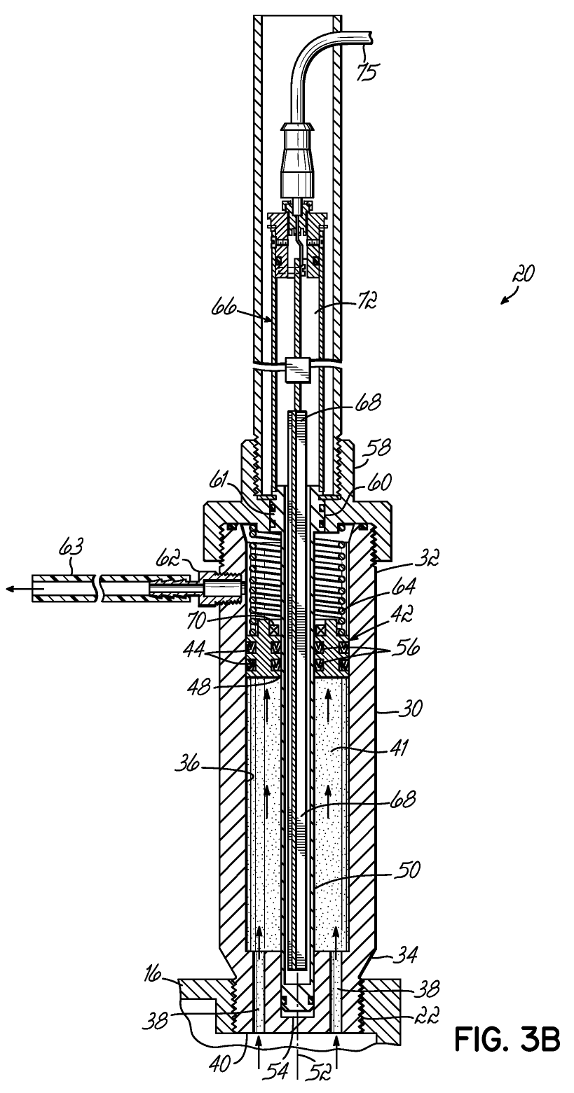

To this end, the fuel dispensing system includes a volumetric leak detector, generally shown at 20, for determining the volume of fuel leakage, if any, from conduit line 14. FIGS. 2, 3A and 3B illustrate an exemplary embodiment of the leak detector 20. Leak detector 20 includes a generally cylindrical body or housing 30 having a proximal end portion 32, a distal end portion 34 and a generally cylindrical interior bore 36. The distal end portion 34 is adapted to be coupled to a port 22 in manifold 16 and may, for example, include a set of external threads that cooperate with a corresponding set of internal threads in port 22 to threadably couple leak detector 20 with pump manifold 16. The invention is not limited to the threaded connection described herein, however, as those of ordinary skill in the art will recognize other ways to couple leak detector 20 with pump manifold 16. Those of ordinary skill in the art will further recognize that the leak detector 20 is not limited to being coupled to pump manifold 16, but may be positioned at any point along the fluid conduit line 14 between the check valve 18 and the dispensing unit 15. The distal end portion 34 of leak detector 20 also includes at least one (two shown) fluid channel 38 having one end open at an end face 40 of distal end portion 34 and the other end open to the interior bore 36. The fluid channel 38 provides fluid communication between the interior bore 36 and fluid conduit line 14 so that when leak detector 20 is coupled to pump manifold 16, fluid may flow into interior bore 36 via fluid channel 38.

In one aspect of the invention, leak detector 20 is not spliced or inserted into conduit line 14 in a manner that restricts flow through conduit line 14, as with prior leak detection systems, but may be ported to a pump manifold 16 without occluding, choking or otherwise creating a flow restriction within conduit line 14. To this end, the distal end portion 34 of the leak detector 20 does not extend beyond port 22 and into the conduit line 14, but instead ends prior to, or at most ends with, the end of port 22 in pump manifold 16, as shown schematically in FIG. 1. Thus, the cross-sectional flow area of conduit line 14 is not restricted by the presence of leak detector 20 and provides a near zero resistance to flow within fluid conduit line 14. In this way, the fuel dispensing system has the capacity to test for a leak in fluid conduit line 14 without also creating a flow restriction that limits the rate at which fuel may be dispensed at the dispensing units 15.

An expansible chamber 41 (FIG. 3B) is defined by a piston 42 positioned in the cylindrical interior bore 36. Piston 42 is adapted to be movable within bore 36 between high and low positions adjacent proximal and distal end portions 32, 34, respectively. Piston 42 includes a first seal 44, such as one or more O-rings, along the periphery of piston 42 so as to create a seal between the piston 42 and the wall of interior bore 36 and therefore prevent or otherwise minimize any fluid leakage around piston 42. Piston 42 further includes a central passageway 48 adapted to receive a hollow shaft 50 that extends along a central axis 52 of interior bore 36 from the proximal end portion 32 to distal end portion 34. Distal end portion 34 includes a blind bore 54 adapted to receive hollow shaft 50 and rigidly affix shaft 50 to cylindrical body 30. For example, hollow shaft 50 may include a set of external threads that cooperate with a corresponding set of internal threads in blind bore 54 to secure hollow shaft 50 to body 30. The invention, however, is not so limited as those of ordinary skill in the art will recognize other ways to couple the hollow shaft 50 to cylindrical body 30. As bore 54 is a blind bore, no fluid may escape leak detector 20 through blind bore 54. Alternately, the end of hollow shaft 50 inserted into bore 54 may include a seal such as a suitably sized O-ring. Additionally, piston 42 further includes a second seal 56, such as one or more O-rings, along central passageway 48 to create a seal between the piston 42 and the hollow shaft 50. In this way, and as shown in FIG. 3B, pressurized fluid that enters the expansible chamber 41 via conduit line 14 and flow channel 38 contacts a lower face of piston 42 and moves piston 42 along central axis 52 but is bounded by piston 42 without a loss of fluid around piston 42.

The proximal end portion 32 of leak detector 20 includes a cap 58 that closes off interior bore 36 and includes a central aperture 60 adapted to receive an adaptor 61 for securing hollow shaft 50 at the proximal end portion 32. Cap 58 may include a set of threads for threadably engaging cap 58 with cylindrical body 30 and a seal for sealing with body 30. Leak detector 20 may further include a vent port 62 adjacent proximal end portion 32. Vent port 62 is in fluid communication with interior bore 36 at one end and in fluid communication with the ullage space in tank 10 (FIG. 1) at the other end via a vent line 63. The vent line 63 prevents any build up of air pressure behind piston 42 as the piston 42 is moved toward proximal end portion 32, such as when bringing the conduit line 14 up to full line pressure. To this end, as the piston 42 is moved toward proximal end portion 32, air is forced through vent port 62 and vent line 63 and therefore maintains a relatively constant pressure behind piston 42.

Leak detector 20 further includes a biasing member that biases the piston 42 toward the distal end portion 34 of detector 20 so that fluid entering expansible chamber 41 must have sufficient pressure in order to move the piston 42 toward the proximal end portion 32 and against the force of the biasing member. For example, and as shown in the figures, in one embodiment the biasing member may be a spring 64. The spring 64 may be a constant rate spring wherein the force imposed by the spring, which then determines the fluid pressure in conduit line 14, varies as a function of displacement of the piston 42 within interior bore 36. For a constant rate spring, leak detection then occurs under variable pressure conditions within the conduit line 14. Detection of leaks under variable pressure conditions is relatively more complicated and may give rise to effects undesirable to highly accurate leak detection, including the compression and expansion of air pockets within conduit line 14.

While a constant rate spring is contemplated for use in embodiments of the invention, in another embodiment of the invention, spring 64 may be a variable rate spring configured such that the biasing force imposed by the spring, and thus the fluid pressure in conduit line 14, remains constant over substantially the entire displacement of the piston 42 within interior bore 36. In this way, any leaks that occur in conduit line 14 occur under constant pressure conditions, which are relatively easier to analyze and identify. Additionally, any volumetric effects from air pockets in conduit line 14 are minimized because their size, which depends on fluid pressure, remains constant during a testing period.

Leak detector 20 further includes a displacement sensor for measuring the linear displacement of piston 42 within interior bore 36. While a great number of displacement sensors exist, the invention contemplates the use of magnetostrictive technology to determine the displacement of piston 42. While magnetostrictive technology is generally known in the art, such sensors are not known to have been used heretofore in line leak detection systems. There may be several reasons for this. One reason may include the expense of more accurate systems than that of less accurate prior art systems, which met less stringent EPA standards or even current standards, even though history shows that more accurate systems have been needed. While there has been a need to provide a more accurate leak detection, it is apparent the industry has not appreciated or recognized the potential use of magnetostrictive technologies and the advantages of the combination of that technology in leak detectors as described herein.

Accordingly, in one embodiment, the displacement sensor may be configured as a magnetostrictive sensor 66 including a magnetostrictive waveguide 68 positioned within hollow shaft 50 and extending the length of interior bore 36 between the proximal and distal end portions 32, 34. As recognized by one of ordinary skill in the art, magnetostrictive waveguide 68 may be formed from a suitable ferromagnetic material, such as iron, nickel or cobalt. Magnetostrictive sensor 66 also includes a permanent magnet 70 coupled to piston 42. For instance, magnet 70 may have an annular configuration having an opening through which magnetostrictive waveguide 68 may be positioned. In this way, as the piston 42 moves due to volumetric changes in conduit line 14, the magnet 70 moves relative to magnetostrictive waveguide 68. The displacement of magnet 70 relative to magnetostrictive waveguide 68 can be sensed by magnetostrictive sensor 66 and may be used to determine if a leak exists in fluid conduit line 14, as explained in more detail below.

Magnetostrictive sensor 66 further includes a sensor control unit 72 coupled to cap 58 of leak detector 20. Control unit 72 houses the necessary electrical components and systems for operation of magnetostrictive sensor 66. In operation, control unit 72 includes an electrical pulse signal generator that generates and sends a current pulse along magnetostrictive waveguide 68. The pulse is transmitted down the magnetostrictive waveguide 68 creating an electromagnetic field along the length of the magnetostrictive waveguide 68. The permanent magnet 70 also generates a magnetic field that interacts with the magnetic field from the current pulse that causes a mechanical twisting of the waveguide 68 (Wiedemann effect) at the location of the permanent magnet 70. The mechanical twisting of magnetostrictive waveguide 68 causes a return pulse in the form of an ultrasonic wave along waveguide 68. Control unit 72 includes a pickup capable of detecting the return ultrasonic pulse. The control unit 72 may be electrically coupled to a central control 74 (FIG. 1), such as by a suitable cable 75, for collecting and analyzing the data signals from magnetostrictive sensor 66. Those of ordinary skill in the art will recognize that some, if not all, of the electrical components in control unit 72 may alternately be located in central control 74.

The location of the piston 42 within the interior bore 36 may be detected by first applying a current pulse to the magnetostrictive waveguide 68. At the same time, a high-speed counter located in control unit 72 is started. When the pulse reaches the permanent magnet 70 an ultrasonic wave is generated and travels back up magnetostrictive waveguide 68 and is detected by the pickup. The counter is then stopped. Since the speed of the ultrasonic wave in waveguide 68 is known, i.e., speed of sound in the waveguide material, the elapsed time between the current pulse and the returned pulse provides an indication of the position or location of the piston 42 along waveguide 68. The control unit 72 repeatedly sends pulsed signals along magnetostrictive waveguide 68 and by comparing the location of the piston 42 for the multiple signals, a displacement of the piston 42 may readily be determined. Because the geometry of interior bore 36 is known, i.e., cross-sectional area of interior bore 36, the displacement of piston 42 may be directly correlated to volumetric changes in conduit line 14

The use of magnetostrictive sensor 66 to determine location (displacement) of the piston 42 has several advantages for line leak detection systems. A primary advantage is the increased sensitivity of the magnetostrictive sensor 66 to displacements of the piston 42 relative to previous sensors currently being used in line leak detection systems. By way of example, magnetostrictive sensors can sense movements on the order of 0.0005 inch while many current displacement sensors used in line leak detection systems require movements one to two orders of magnitude larger. As a result, the sensitivity of the magnetostrictive sensor 66 to relatively small displacements permit a large number of data points to be sampled and analyzed in order to determine if a leak exists in conduit line 14. For example, for a two inch stroke of piston 42 in interior bore 36, approximately 10,000 data points corresponding to detectable positions of piston 42 may be sampled and analyzed. The increased number of data points in turn permits a more accurate and reliable determination of the presence of a line leak.

The sensitivity of the magnetostrictive sensor 66 also permits a relatively large data set to be sampled in a shorter period of time than heretofore available in current leak detection systems. Thus, for example, with a magnetostrictive sensor, a data set that may be reliably used to determine a line leak may take orders of magnitude less time than the devices currently being used. For instance, in one embodiment of the invention, thousands of valid data points may be used to determine if a leak exists in conduit line 14. Due to the sensitivity of magnetostrictive sensor 66, these thousands of data points may be taken in a very short period of time relative to the amount of time of current sensors to generate an equal amount of data points.

The ability to obtain a reliable data set in a relatively short period of time provides additional advantages for line leak detection systems. For instance, the negative effects of thermal variations in the conduit line may be minimized by minimizing the sampling or testing time. As recognized by those of ordinary skill in the art, thermal variations in the conduit line (e.g. temperature differences between the fuel and piping system and ground) may be characterized by a thermal time constant that generally indicates the amount of time for the system to react to the thermal variations. For fuel dispensing systems, such as at gas stations, this time constant may be on the order of several minutes. Accordingly, the ability of the magnetostrictive sensor to gather a reliable data set in a relatively short period of time and in a period of time shorter than the thermal time constant of the dispensing system, eliminates, or at least significantly reduces, the impact of thermal variations on the determination of a leak in the conduit line. Eliminating thermal effects removes this as a potential source of volume change and thus increases the accuracy and reliability of line leak detection systems.

Yet another advantage of using magnetostrictive sensor 66 to determine the location (displacement) of piston 42 is that much smaller volumetric changes in the conduit line 14 may be accurately detected. Small leaks that would not otherwise be detected by many of the current line leak detectors would be detectable using magnetostrictive sensor 66. Thus, prophylactic measures may be taken at a much earlier stage than currently possible to prevent a possible catastrophic event and to prevent or reduce the amount of environmental damage resulting from the leak.

It is anticipated that in the future, more restrictive EPA regulations will be implemented that require gas stations and other fuel dispensing systems to detect much smaller leaks than are currently required. In that case, many current line leak detectors will be inadequate and unable to meet the more stringent regulations. The leak detector of the invention, however, is capable of such small leak detection, and detection may be accomplished in a relatively short period of time and with the required accuracy and reliability required by such leak detection systems.

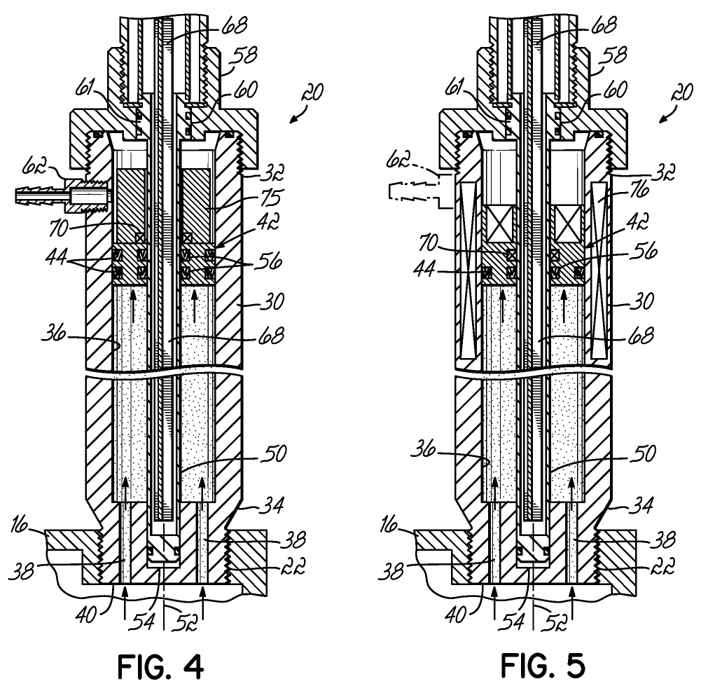

While the biasing member in FIGS. 2-3B is shown and described as spring 64, the biasing member is not limited to a spring as there are other ways to apply a biasing force against movement of the piston 42 in accordance with alternate embodiments of the invention. For example, and as illustrated in FIG. 4 in which like reference numerals refer to like features in FIGS. 2-3B, instead of a spring applying the biasing force to the piston 42, the biasing member may take the form of a weight 75 coupled to piston 42. The weight 75 may be integrally formed with the piston 42, or alternately the weight 75 may be coupled to the piston 42 through a separate assembly process. In any event, the weight 75 operates in a similar manner as the variable rate spring in that the biasing force imposed by weight 75, and thus the fluid pressure in conduit line 14, remains constant over substantially the entire displacement of the piston 42 within interior bore 36. Thus, any leaks that occur in conduit line 14 occur under constant pressure conditions, which as noted above are relatively easier to analyze and identify.

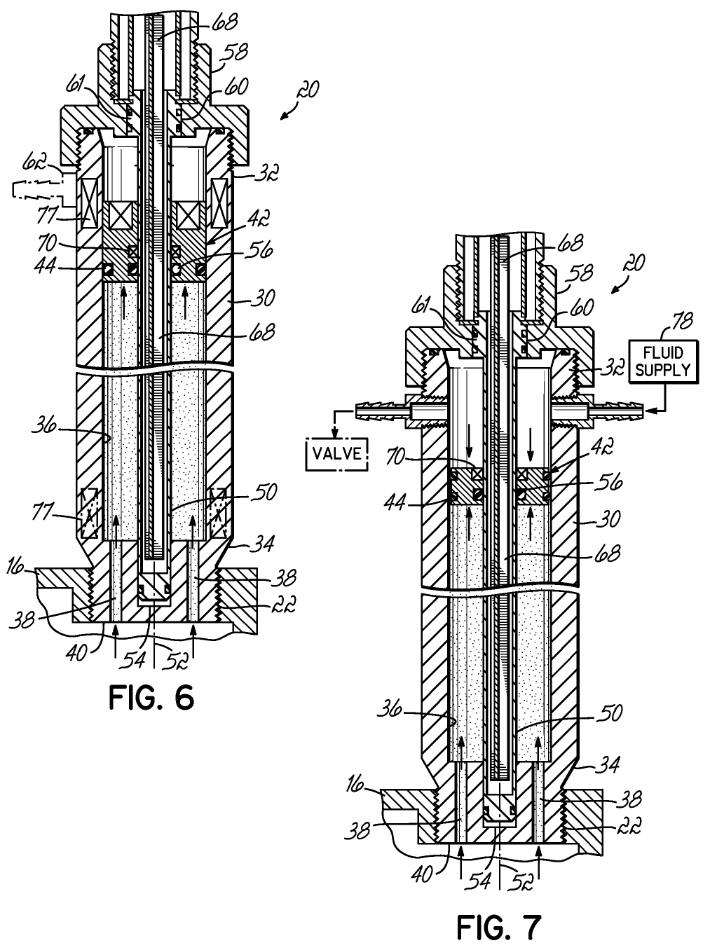

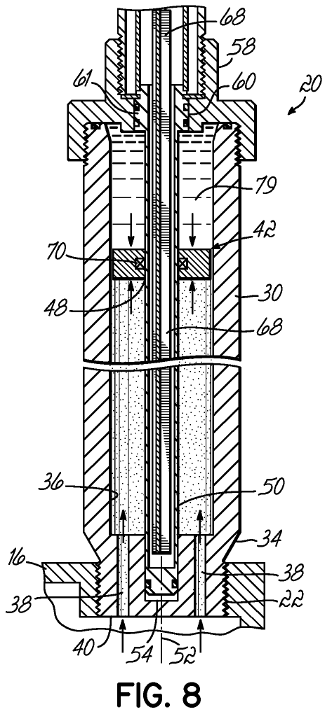

FIGS. 5 and 6, in which like reference numerals refer to like features in FIGS. 2-3B, show additional embodiments in accordance with the invention. In these embodiments, the biasing member is configured as a magnet for imposing the biasing force on the piston 42. In FIG. 5, the magnet is configured as an electromagnet 76, such as a solenoid. In particular, the electromagnet 76 includes a coil operatively coupled to a power source (not shown) for creating a controllable magnetic field when a current flows through the coil. The electromagnet 76 may be configured such that the magnetic filed then imposes a relatively uniform force, i.e., the biasing force, for resisting movement of the piston 42 toward the proximal end portion 32 of leak detector 20. Again, similar to the variable rate spring, the biasing force imposed by electromagnet 76, and thus the fluid pressure in conduit line 14, remains constant over substantially the entire displacement of the piston 42 within interior bore 36. Thus, any leaks that occur in conduit line 14 occur under constant pressure conditions.

The embodiment shown in FIG. 6 also uses a magnet as the biasing member, but in this embodiment, the magnet is a permanent magnet 77. This may result in a simpler design, eliminating the need to couple the biasing member to a power source. The permanent magnet 77 may be positioned adjacent the proximal end portion 32 of the leak detector 20. In this case, the magnet 77 may have a polarity the same as that of magnet 70 on piston 42. In this way, magnet 77 creates a biasing force that opposes motion of the piston 42 toward the magnet 77 (i.e., biases the piston 42 toward the distal end portion 34) due to similar pole magnets repelling each other. In an alternate embodiment similar to that shown in FIG. 6, the permanent magnet 77 may be positioned adjacent the distal end portion 34 (shown in phantom in FIG. 6). In this case, the magnet 77 may have the opposite polarity as that of magnet 70 on piston 42. In this way, magnet 77 creates a biasing force that opposes motion of the piston 42 away from magnet 77 (i.e., biases the piston 42 toward the distal end portion 34) due to opposite pole magnets attracting each other. For the embodiments shown in FIG. 6, the permanent magnet 77 operates similar to a constant rate spring in that the force imposed by the magnet 77, which then determines the fluid pressure in conduit line 14, varies as a function of separation of the magnet 77 relative to magnet 70 on piston 42. For a permanent magnet, leak detection then occurs under variable pressure conditions within the conduit line 14. The attracting/repelling force of magnets as a function of separation distance, are readily known by those of ordinary skill in the art and may be accounted for in determining whether a line leak has occurred. Although magnet 77 operates in cooperation with magnet 70 on piston 42, a separate magnet may be coupled to piston 42 for use with magnet 77.

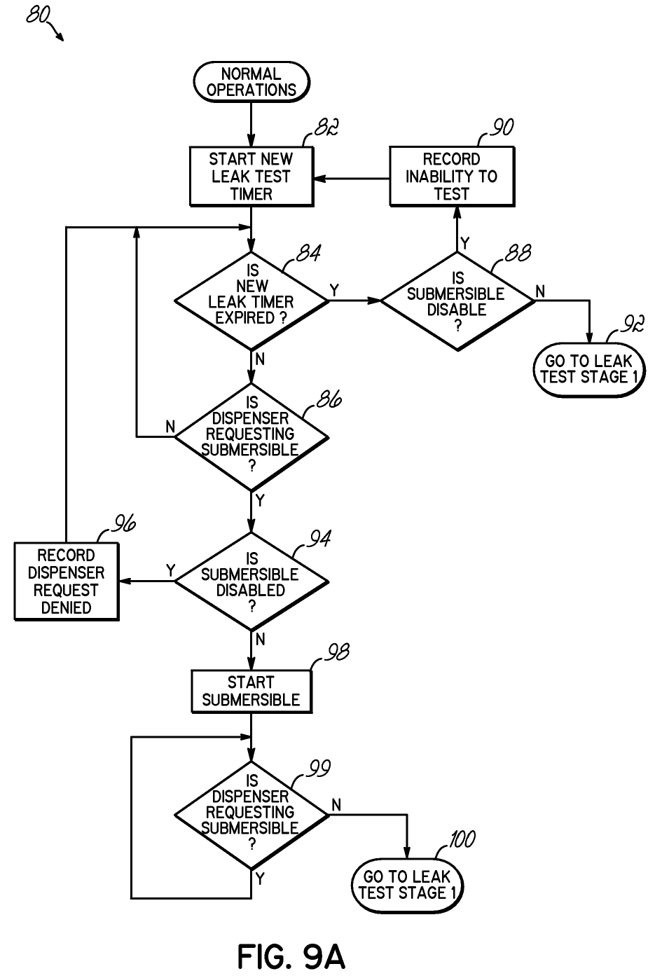

In still another embodiment, and as shown in FIG. 7, the biasing member may be configured as a pressurized fluid supply, shown schematically at 78, for imposing the biasing force on the piston 42. For example, the fluid supply 78 may be a gas supply for pneumatically pressurizing the interior bore 36 above the piston 42. Alternately, the fluid supply 78 may be a liquid supply for hydraulically pressurizing the interior bore 36 above the piston 42. In either embodiment, the fluid supply 78 may be regulated so that the biasing force imposed by the pressurized fluid above the piston 42, and thus the fluid pressure in conduit line 14, remains constant over substantially the entire displacement of the piston 42 within interior bore 36. Thus, any leaks that occur in conduit line 14 occur under constant pressure conditions. In this embodiment, the vent port 62 and vent line 63 may be eliminated, or alternately include a valve for selectively opening and closing fluid communication between the interior bore 36 above the piston 42 and the tank 10, as previously described.

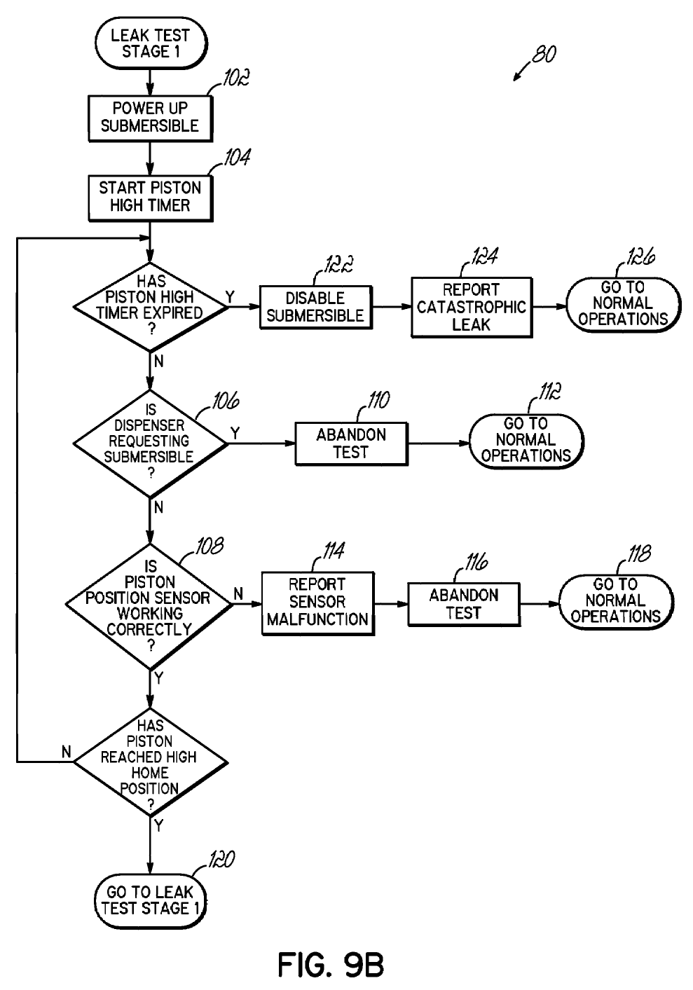

FIG. 8 shows yet another embodiment of the invention, wherein the biasing member is configured as a compressible gas pocket 79. In this embodiment, the proximal end portion 32 of the leak detector 20 is totally sealed off, i.e., the vent port 62 and vent line 63 would be eliminated or again include a valve for selectively opening and closing fluid communication between the interior bore 36 above the piston 42 and the tank 10. When the pocket 79 is sealed off, the gas contained therein imposes a biasing force on the piston 42, due to the pressure of the gas. The gas pocket 79 operates similar to a constant rate spring in that the biasing force on the piston 42 varies as a function of displacement of the piston 42 within interior bore 36. For example, as the piston 42 moves toward the proximal end portion 32, the pressure of the gas pocket 79 and thus the biasing force on the piston 42 would increase. Moreover, as the piston 42 moves toward the distal end portion 34, the pressure of the gas pocket 79 and thus the biasing force on the piston 42 would decrease. Accordingly, leak detection then occurs under variable pressure conditions within the conduit line 14. The compressibility of gases, such as air or other suitable gases, are readily known by those of ordinary skill in the art and may be accounted for in determining whether a line leak has occurred.

While leak detection occurs under variable pressure conditions within conduit line 14, the embodiment shown in FIG. 8 provides a number of advantages. In one aspect, the piston 42 may be configured as a simple buoyant float positioned on top of the liquid within leak detector 20. Because the gas pocket 79 created between the top of the liquid and the proximal end portion 32 of the leak detector 20 provides the biasing force, there is no longer a need to maintain a fluid tight seal between the piston 42 and the wall of interior bore 36, such as that performed by seals 44. There is also no need to maintain a fluid tight seal between the central passageway 48 of piston 42 and the hollow shaft 50, such as that performed by seals 56. Thus, the piston 42 may have an outer dimension less than the dimension of the interior bore 36. Similarly, the central passageway 48 may have a dimension greater than the dimension of the hollow tube 50. The piston 42 in this embodiment therefore has a much simpler design, incorporating fewer parts (e.g., no seals). Moreover, friction effects between the movable piston 42 and the stationary portions of leak detector 20 are no longer problematic in this design, as close contact between the piston 42 and the interior bore 36 and hollow shaft 50 is avoided. This in turn may provide more accurate data. This design also avoids problems of wear on the piston seals and leaks past the piston, which may give a false indication of a leak.

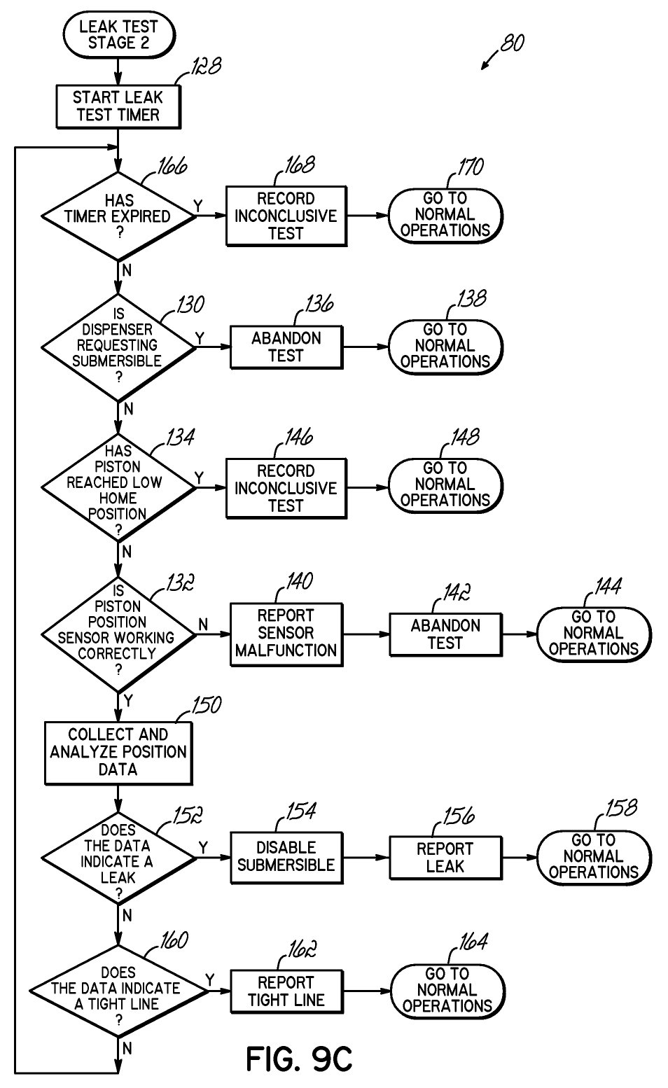

FIGS. 9A-9C are flow charts illustrating operation of leak detector 20 in an exemplary leak detection system 80. With the fuel dispensing system at normal operations, a leak test timer is started at 82. The leak detection system 80 then operates in a loop configured to run a test after a sufficiently long period of inactivity. For example, if a dispenser unit 15 has not operated in several hours, e.g. the dispensing unit 15 is inactive during overnight hours; a test may be initiated after such a period of inactivity. To this end, leak detection system 80 continually checks if the test timer has expired at 84 and whether a dispensing unit 15 is requesting the submersible pump 12 at 86. If the test timer has expired due to a sufficiently long period of inactivity, the leak detection system 80 checks if the submersible pump 12 has been disabled at 88. For instance, a pump 12 may be disabled if a prior test indicated that a leak exists in the conduit line 14. Of course, the leak detection system 80 will not permit any fuel dispensing from a dispensing unit 15 coupled to conduit line 14 for which a leak has been detected. If the submersible pump 12 is disabled, the inability to test is recorded at 90. If the submersible pump 12 is not disabled, then the leak detection system 80 proceeds to a first stage test at 92.

If prior to the expiration of the test timer, a dispensing unit 15 requests pump 12, the leak detection system 80 again checks if the submersible pump 12 has been disabled at 94. If the pump 12 has been disabled (e.g. a prior leak test indicated a leak in the conduit line 14), the dispenser request is denied and recorded at 96. If, on the other hand, pump 12 has not been disabled then the pump 12 is started at 98 in order to dispense fuel from dispensing unit 15. The leak detection system 80 then operates in a second loop configured to run a leak test at the end of the dispensing process, as the conduit line 14 is at full line pressure. To this end, the leak detection system 80 checks if the dispensing unit 15 is still being requested at 99. If the dispensing unit 15 is no longer being requested, i.e., the dispensing process has ended, then the leak detection system 80 proceeds to the first stage test at 100.

The first stage test is configured to determine whether a catastrophic leak exists in conduit line 14. To this end, the submersible pump 12 is powered up at 102 in order to bring conduit line 14 up to normal, full line pressure. A timer is started at 104 to determine the amount of time it takes for the piston 42 to reach its high or top most position within interior bore 36. The high position is reached when the pressure in conduit line 14 is at the full line pressure. In operation, the leak detection system 80 checks whether a dispensing unit 15 is requesting the submersible pump 12 at 106 and also checks the proper operation of the magnetostrictive sensor 66 at 108. If a dispensing unit 15 is requesting the pump 12, the test is abandoned at 110 and the leak detection system 80 returned to normal operations at 112. If the magnetostrictive sensor 66 is not working properly, the malfunction is reported to an operator at 114 and the test is abandoned at 116 and the leak detection system 80 returned to normal operations at 118. If the piston 42 reaches its high position before the expiration of the timer, there is no catastrophic leak in the conduit line 14 and the system 80 proceeds to a second stage test at 120 as discussed below. If, on the other hand, the piston 42 does not reach its high position before the expiration of the timer, then a catastrophic leak exists in the conduit line 14 and the submersible pump 12 is disabled at 122. The catastrophic leak is then reported to an operator at 124 and the leak detection system 80 otherwise returned to normal operations at 126.

If the dispensing system passes the catastrophic test, as described above, then the leak detection system 80 proceeds onto a second stage test where a more precise leak test is conducted. In this stage, a timer is started at 128. Again, the leak detection system 80 checks whether a dispensing unit 15 is requesting the submersible pump 12 at 130 and also checks the proper operation of the magnetostrictive sensor 66 at 132. In addition, the leak detection system 80 checks to ensure that the piston 42 has not reached its low or bottom most position at 134. If a dispensing unit 15 is requesting the pump 12, the test is abandoned at 136 and the leak detection system returned to normal operations at 138. If the magnetostrictive sensor 66 is not working properly, the malfunction is reported to an operator at 140 and the test is abandoned at 142. The leak detection system 80 is then returned to normal operations at 144. If the piston 42 has reached its low position, then an inconclusive test is recorded at 146 and the leak detection system 80 returned to normal operations at 148.

If the submersible pump 12 is not being requested, the magnetostrictive sensor 66 is working properly, and the low position of the piston 42 has not been reached, then the leak detection system 80 collects and analyzes position data of the piston 42 at 150 to determine volumetric changes in the conduit line 14. To this end, the data may be sent to a central control 74 where the data is analyzed according to a pre-programmed algorithm configured to identify a leak in conduit line 14 based on the data. The algorithm is not a part of the present invention, but is used to draw a conclusion about a leak in conduit line 14. One outcome of the algorithm is that the data indicates the presence of a leak in conduit line 14. Such an outcome is indicated at 152. In this case, the submersible pump 12 is disabled at 154 and the leak is reported to an operator at 156. The leak detection system 80 is then otherwise returned to normal operations at 158. Another outcome of the algorithm is that the conduit line 14 is tight and no leak exists, as indicated at 160. In this case, the tight line is reported to an operator at 162 and the leak detection system 80 is returned to normal operations at 164. Yet another outcome of the algorithm is that the data is inconclusive. In this case, the leak detection system 80 returns to 166 to continue the testing process. If a conclusion of the test is not reached prior to the timer expiring, an inconclusive test is recorded at 168 and the leak detection system 80 returned to normal operations at 170

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. An apparatus for detecting volumetric changes in a liquid volume comprising:
a housing defining an interior bore therein;
a piston disposed in the interior bore and movable along the interior bore, the interior bore and piston defining an expansible chamber;
a biasing member for biasing the piston against movement within the interior bore;
a liquid passage extending from the liquid volume to the expansible chamber; and
a magnetostrictive sensor including a magnetostrictive waveguide, a magnet operably connected to the piston for movement therewith and in operative relation to said magnetostrictive waveguide, and pulsing and detection devices for detecting a position of the magnet along the magnetostrictive waveguide.

2. The apparatus of claim 1, wherein the biasing member is selected from the group consisting of a constant rate spring, a variable rate spring, a weight, an electromagnet, a permanent magnet, a fluid supply, and a sealed gas pocket.

3. The apparatus of claim 2, wherein the fluid supply is one of a pneumatic or hydraulic supply.

4. The apparatus of claim 1, wherein the biasing member imposes a fluid pressure in the liquid volume that varies with movement of the piston within the interior bore.

5. The apparatus of claim 1, wherein the biasing member imposes a fluid pressure in the liquid volume that remains relatively constant with movement of the piston within the interior bore.

6. The apparatus of claim 1, wherein the biasing member is disposed on a side of the piston opposite the expansible chamber.

7. The apparatus of claim 1, further comprising a vent port disposed on a side of the piston opposite the expansible chamber.

8. The apparatus of claim 1, wherein the piston further includes at least one seal along a periphery of the piston adapted to form a seal with the interior bore of the housing.

9. The apparatus of claim 1, further comprising:
a hollow shaft positioned in the interior bore and extending between the proximal and distal end portions, the magnetostrictive waveguide positioned within the hollow shaft,
wherein the piston includes a central passageway for receiving the hollow shaft therethrough and moving within the interior bore along the hollow shaft.

10. The apparatus of claim 9, wherein the piston further includes at least one seal along the central passageway adapted to form a seal with the hollow shaft.

11. The apparatus of claim 1, wherein the piston is configured as a buoyant float.

12. The apparatus of claim 1, wherein the magnetostrictive waveguide and the magnet are disposed on a side of the piston opposite the expansible chamber.

13. A dispensing system, comprising:
a tank for holding a liquid;
a dispensing unit for dispensing the liquid;
a fluid conduit line providing fluid communication between the tank and the dispensing unit;
a one-way valve disposed in the fluid conduit line, the portion of the fluid conduit line between the valve and the dispensing unit defining a liquid volume; and
a leak detector in communication with the fluid conduit line and adapted to detect volumetric changes in the liquid volume, the leak detector comprising:
a housing defining an interior bore therein;
a piston disposed in the interior bore and movable along the interior bore, the interior bore and piston defining an expansible chamber;
a biasing member for biasing the piston against movement within the interior bore;
a liquid passage extending from the liquid volume to the expansible chamber; and
a magnetostrictive sensor including a magnetostrictive waveguide, a magnet operably connected to the piston for movement therewith and in operative relation to said magnetostrictive waveguide, and pulsing and detection devices for detecting a position of the magnet along the magnetostrictive waveguide.

14. The dispensing system of claim 13, wherein the biasing member is selected from the group consisting of a constant rate spring, a variable rate spring, a weight, an electromagnet, a permanent magnet, a fluid supply, and a sealed gas pocket.

15. The dispensing system of claim 14, wherein the fluid supply is one of a pneumatic or hydraulic supply.

16. The dispensing system of claim 13, wherein fluid flow through the fluid conduit line is unimpeded by the leak detector.

17. The dispensing system of claim 13, further comprising a central control for analyzing the position data from the magnetostrictive sensor and determining whether a leak exists in the fluid conduit line.

18. A method of detecting changes in a liquid volume, comprising:
exposing the liquid in the liquid volume to an expansible chamber apparatus comprising a housing having an interior bore and a piston movable along the interior bore in response to changes in the liquid volume; and
sensing changes in the liquid volume magnetostrictively by causing relative movement of one of a magnetostrictive waveguide or a magnet operatively disposed proximate the magnetostrictive waveguide upon movement of the piston and obtaining data from the movement representative of piston movement responsive to volumetric changes in the liquid volume.

19. The method of claim 18, further comprising:
biasing the movement of the piston against volumetric changes in the liquid volume.

20. The method of claim 19, wherein biasing the movement of the piston is caused by a biasing member selected from the group consisting of a constant rate spring, a variable rate spring, a weight, an electromagnet, a permanent magnet, a fluid supply, and a sealed gas pocket.

21. The method of claim 19, wherein biasing the movement of the piston comprises imposing a fluid pressure in the liquid volume that varies with movement of the piston within the interior bore.

22. The method of claim 19, biasing the movement of the piston comprises imposing a fluid pressure in the liquid volume that remains relatively constant with movement of the piston within the interior bore.

23. The method of claim 118, further comprising:
transporting liquid within a liquid delivery line having a cross-sectional flow area; and
exposing liquid from the liquid delivery line to the expansible chamber without restricting the cross-sectional flow area of the liquid delivery line.
